(19) United States
(12) Patent Application Publication
(10) Pub. No.: US 2025/0107552 A1
(43) Pub. Date: Apr. 3, 2025

(54) SYSTEM AND METHOD FOR SEPARATING ORGANIC MATTER AND INORGANIC MATTER FROM EGG BY-PRODUCTS MATERIAL COMPRISING AT LEAST UNHATCHED EGG BY-PRODUCTS

(71) Applicant: IsoNova Technologies, LLC, Springfield, MO (US)

(72) Inventors: Joel Bartley, Florissant, MO (US); Ingomar Stefan Middelbos, Chersterfield, MO (US); Joshua Nelson, Springfield, MO (US)

(21) Appl. No.: 18/899,819

(22) Filed: Sep. 27, 2024

Related U.S. Application Data
(60) Provisional application No. 63/586,228, filed on Sep. 28, 2023.

(51) Int. Cl. A23J 1/08; A23K 10/26; A23K 20/147; A23K 20/24; A23K 50/40; A23L 15/00

(52) U.S. Cl. CPC A23J 1/08; A23K 10/26; A23K 20/147; A23K 20/24; A23K 50/40; A23L 15/00

(57) ABSTRACT

A method of separating organic matter and inorganic matter from egg by-products material includes a drying step, a milling step, and a separating step. In the drying step, an amount of egg by-products material is dried to create a dried egg by-products material. During the milling step, the dried egg by-products material is milled to create a milled egg by-products material. The milled egg by-products material is then separated into an amount of organic matter and an amount of inorganic matter in the separating step. The egg-by products material includes at least unhatched egg by-products.

### CROSS-REFERENCE TO RELATED APPLICATIONS

This application claims the benefit of priority of U.S. Provisional Patent Application No. 63/586,228, filed Sep. 28, 2023, the entire disclosure of which is incorporated herein by reference.

### FIELD OF INVENTION

The disclosure relates generally to methods of processing eggshell material. More specifically, the disclosure relates to methods and systems for separating organic matters and inorganic matters from egg by-products material comprising at least unhatched egg by-products.

### SUMMARY

This summary is provided to introduce a selection of concepts in a simplified form that are further described below in the detailed description. This summary is not intended to identify key features or essential features of the claimed subject matter, nor is it intended to be used to limit the scope of the claimed subject matter. Other aspects and advantages of the invention will be apparent from the following detailed description of the embodiments and the accompanying drawing figures.

According to an embodiment of the invention, a method of separating organic matter and inorganic matter from egg by-products material includes a drying step, a milling step, and a separating step. The egg by-products material includes at least unhatched egg by-products. In the drying step, an amount of egg by-products material is dried to create a dried egg by-products material. During the milling step, the dried egg by-products material is milled to create a milled egg by-products material. The milled egg by-products material is then separated into an amount of organic matter and an amount of inorganic matter in the separating step.

### BRIEF DESCRIPTION OF THE DRAWINGS

Embodiments of the invention are described in detail below with reference to the attached drawings.

FIG. 1 is a first schematic of an embodiment of a system and method for separating organic matters and inorganic matters from egg by-products material comprising at least unhatched egg by-products.

FIG. 2 is a second schematic of an embodiment of a system and method for separating organic matter and inorganic matter from egg by-products material.

The drawings do not limit the invention to the specific embodiments disclosed and described herein. The drawings are not necessarily to scale, emphasis instead being placed upon clearly illustrating various principles of the disclosure.

### DETAILED DESCRIPTION

In this description, references to “one embodiment,” “an embodiment,” or “embodiments” mean that the feature or features being referred to are included in at least one embodiment of the technology. Separate references to “one embodiment,” “an embodiment,” or “embodiments” in this description do not necessarily refer to the same embodiment and are also not mutually exclusive unless so stated and/or except as will be readily apparent to those skilled in the art from the description. For example, a feature, structure, act, etc. described in one embodiment may also be included in other embodiments but is not necessarily included. Thus, the technology can include a variety of combinations and/or integrations of the embodiments described herein.

Eggs are an important and popular food product and are produced in large quantities in the United States. It is estimated that approximately 50 billion eggs are produced each year in the U.S., most of which are chicken eggs, with many of these eggs coming from high production facilities. These high production facilities use conventional processes to create value from the egg portion, but also generate a large volume of egg by-products, including eggshells which are commonly transported to landfills. However, these egg by-products contain valuable components. There are two major components in eggshell material: the membrane and the shell. The membrane represents about 6% of the eggshell material. The membrane is an organic matter and consists mainly of proteins (amino acids), including collagen. These can be used in the medical and cosmetic industries, among others. The shell represents about 94% of the eggshell material. The shell is an inorganic matter and mainly consists of minerals, in particular calcium, more precisely calcium carbonate (CaCO₃), which has a variety of applications. Many of these applications require the calcium carbonate product to be of a high purity.

Current systems and processes for making effective separation and use of these eggshell material focus almost exclusively on grader and breaker eggshell membranes and hatchery eggshells where pieces are whole or halves, in other words, eggshells that are mostly intact. Processes for separating the organic matter (membrane) from the inorganic matter (shell) generally include washing away the remaining albumen and yolk and then separating the membrane from the shell by air separation, fluid cavitation or pulsed energy.

Hatchery facilities generate wastes, also known as egg by-products. These egg by-products can include infertile eggs, eggshells, unhatched egg by-products (obtained from fertilized eggs containing embryo which did not hatch within the incubation period, these unhatched egg by-products comprising embryos and eggshell material) and dead chicks (such as culled chicks). In practice, these egg by-products from hatcheries may be discarded together. However, conventional systems and processes are unable to handle and separate these egg by-products with higher organic matter. In particular, it is extremely difficult to separate the shell (inorganic matter) from other organic matter (membranes, embryos, dead chicks etc.).

Embodiments presented herein provide a way to separate organic matter and inorganic matter from egg by-products material comprising at least unhatched egg by-products. Systems and methods discussed herein provide opportunities to save on costs associated with sending these by-products to a landfill, and to generate revenue by selling the separated organic and inorganic matter, such as for use in animal feed.

Herein is disclosed a method of separating organic matter and inorganic matter from egg by-products material comprising at least unhatched egg by-products which includes a drying step wherein an amount of egg by-products material is dried to create a dried egg by-products material; a milling step wherein the dried egg by-products material is milled to create a milled egg by-products material; and a separating step wherein the milled egg by-products material is separated into an amount of organic matter and an amount of inorganic matter.

The egg by-products material may be obtained from one or more conventional egg processing operations, e.g. from hatchery wastes, as would be understood by those skilled in the art. The egg by-products material contains at least unhatched egg by-products. As above explained, these unhatched egg by-products comprise at least embryos, membranes, shells. Given the presence of embryos that may be at different stages of maturity, feathers may be present in the unhatched by-products.

The egg by-products material can also comprise other types of egg by-products, for example eggs (such as infertile eggs, unclassified eggs), eggshell materials (for example eggshells material that remain after the chick has hatched) and/or dead chicks (such as culled chicks).

In one embodiment, the egg by-products material contains at least 10%, or at least 15%, or at least 20%, or from 15% to 50% of organic matter (depending on the proportion of unhatched eggs by-products). In one embodiment, it comprises about 35% by weight of organic matter.

When used herein, the terms “organic matter” refers to the sources of proteins, fats and/or carbohydrates and include for example membranes, embryos, dead chicks, feathers. When used herein, the terms “inorganic matter” refers to the sources of minerals, such as calcium and magnesium (and more precisely calcium carbonate, calcium phosphate and magnesium carbonate), and include for example shells.

This invention thus enables to separate organic matter and inorganic matter so as to obtain an organic matter and an inorganic matter via a separation step, such as at least by density. For example, the invention enables to separate shells (inorganic matter) from membranes, embryos and other organic matters. This is made possible thanks to the pre-treatment applied prior to this separation with the drying and milling steps.

In one embodiment, the egg by-products material can contain more than 40% by weight and up to 90% by weight inorganic matter, depending on the proportion of unhatched eggs by-products. In one embodiment, it comprises about 65% by weight inorganic matter.

The egg by-products material may undergo a pre-processing step to prepare the material for the separation process further described below. This pre-processing step can consist of removing the liquid from the material to create a macerated egg by-products material. In a preferred embodiment, the one or more types of egg by-products may preferably be pressed to remove liquid from the material. Pressing the liquid out of the material results in macerated (i.e., crushed) egg by-products material. This preferred embodiment eliminates the need for an additional step of washing the eggshell material to remove liquid egg from the mixture. This helps save water or other washing liquids. Alternative means of removing the egg liquid from the egg by-products material may also be used, such as washing the material to remove egg liquid. In such instances, it may be preferable for the material to undergo a second pre-processing step such as a crushing or chopping step to provide macerated egg by-products material. In any case, the liquid egg removed from the eggshell material may be utilized to produce valuable by-products, such as nutritional egg powder, as is known in the art.

The egg by-products material (typically macerated) is then dried to create a dried egg by-products material. Drying step is routine work for the skilled artisan. Typically, drying is performed in a drier so as to remove any excess water. In embodiments, the egg by-products material is dried from a moisture level above 25% by weight to a moisture level below 10% by weight, preferably below 7% by weight, and most preferably below 5% by weight. In embodiments, it may be preferable for the moisture content of the dried egg by-products material to be less than about 3% by weight.

The dried egg by-products material is then milled to create a milled egg by-products material. The term “milling” refers to the reducing of the particle size. Any milling machine may be utilized, such as a machine with a cutting mechanism and/or a grinding mechanism, preferably at least a cutting mechanism. The milling machine may produce material with a predetermined particle size, for example a particle size preferably below 12 mm, more preferably below 6 mm, more preferably below 4 mm, most preferably between 1 mm and 3 mm.

In embodiments, the milled egg by-products material is separated into an amount of organic matter and an amount of inorganic matter based on density of the organic matter and the inorganic matter. Any machine may be utilized, such as a gravity separator. The separating step by density can be repeated to optimize the separation of inorganic matter from organic matter.

In one embodiment, the separating step can further comprise a sieving step, after the separating step by density, to further separate inorganic matter from organic matter based on particle size. This embodiment can be used when the separation by density does not enable to fully separate some organic and inorganic matters. Preferably, the additional separation by sieving is performed by vibration sieving.

For example, separating by density the milled material could result in a first organic matter stream (e.g. feathers and a part of eggshell membranes), a second inorganic matter stream (e.g. a part of shells), and a third stream comprising organic and inorganic matter (the remaining shells and membranes). The third stream is sieved into a fourth stream comprising organic matter (membranes) and a fifth stream comprising organic matter (shells). The inorganic matter is thus obtained in the second and the fifth streams and can be further processed. The organic matter is obtained in the first and fourth streams and can be further processed.

Further steps of processing can be performed in order to provide from these separated valuable products.

The inorganic matter obtained from the method (mainly shells) contains a high amount of minerals, in particular calcium, preferably calcium carbonate. In one embodiment, the method comprises a processing step wherein the obtained amount of inorganic matter is processed to form eggshell calcium. The processing step can include milling the obtained inorganic matter. The eggshell calcium obtained can contain at least 87.5%, or 90%, of calcium carbonate. The eggshell calcium obtained can contain at least 35% of (elemental) calcium.

The present invention can also relate to a method for preparing eggshell calcium, with the steps as above described. For example, the method for preparing eggshell calcium from egg by-products material comprising at least unhatched egg by-products, comprises:
a drying step wherein an amount of egg by-products material is dried to create a dried egg by-products material;
a milling step wherein the dried egg by-products material is milled to create a milled egg by-products material; and
a separating step wherein the milled egg by-products material is separated into an amount of organic matter and an amount of inorganic matter,
a processing step wherein the obtained amount of inorganic matter is processed to form eggshell calcium.

The present invention also concerns eggshell calcium obtained according to the method here described.

The present invention concerns the use of this eggshell calcium in animal feed, in particular in pet food.

The organic matter obtained from the method is mainly (dried and milled) membranes, embryos, dead chicks. This can be used to provide organic matter products. In one embodiment, the method comprises a processing step wherein the obtained amount of organic matter is processed to form an eggshell membrane product. For example, the organic matter obtained from the separation step (e.g. by density, and optionally sieving) can contain different products: a first organic matter product containing at least a part of (dried and milled) feathers and a second organic matter product containing at least a part of (dried and milled) membranes, embryos, dead chicks. The second organic matter product can form a valuable product, hereafter named “eggshell membrane product”. Typically, the obtained eggshell membrane product is a powder that preferably has a protein content equal to or greater than about 50%, and preferably a collagen content equal to or greater than 2.5%.

The present invention can also to a method for preparing an eggshell membrane product, with the steps as above described. For example, the method for preparing an eggshell membrane product from egg by-products material comprising at least unhatched egg by-products, comprises:
a drying step wherein an amount of egg by-products material is dried to create a dried egg by-products material;
a milling step wherein the dried egg by-products material is milled to create a milled egg by-products material; and
a separating step wherein the milled egg by-products material is separated into an amount of organic matter and an amount of inorganic matter,
a processing step wherein the obtained organic matter is processed to form an eggshell membrane product.

The present invention concerns an eggshell membrane product obtained according to the methods here described.

The present invention concerns the use of this eggshell membrane product in animal feed, in particular in pet food.

The present invention also concerns a method for preparing eggshell calcium and an eggshell membrane product, with the steps as above described. For example, the method for preparing eggshell calcium and an eggshell membrane product from egg by-products material comprising at least unhatched egg by-products, comprises:
a drying step wherein an amount of egg by-products material is dried to create a dried egg by-products material;
a milling step wherein the dried egg by-products material is milled to create a milled egg by-products material; and
a separating step wherein the milled egg by-products material is separated into an amount of organic matter and an amount of inorganic matter,
a processing step wherein the obtained organic matter is processed to form an eggshell membrane product and the obtained amount of inorganic matter is processed to form eggshell calcium.

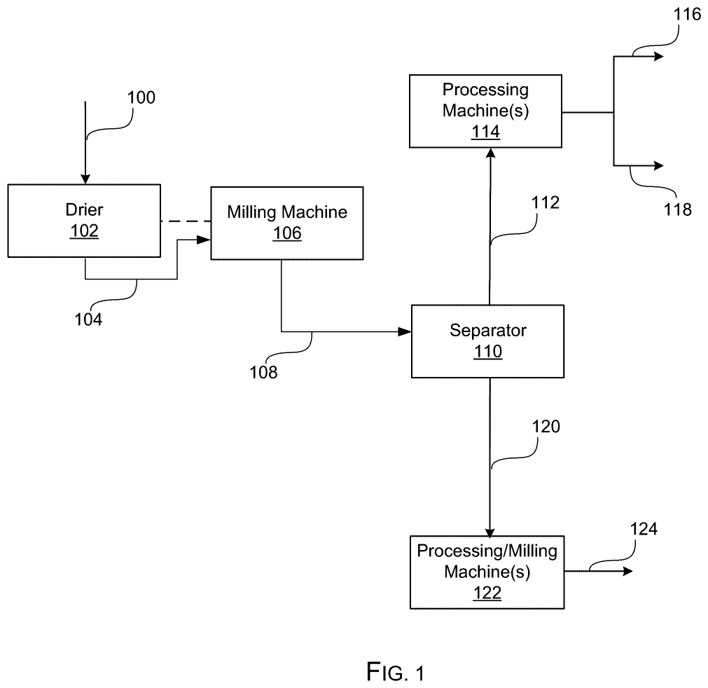

FIG. 1 illustrates an embodiment of a system and method for separating organic and inorganic matter from an egg by-products material in accordance with the invention, preferably macerated egg by-products material. First, an amount of egg by-products material (typically macerated) 100 is dried in a drier 102 to produce a dried egg by-products material 104 which is subsequently milled in a milling machine 106 to produce a milled egg by-products material 108. Although shown separately in FIG. 1, drying and milling the egg by-products material 100 may be accomplished with a single machine in one or more steps, resulting in the milled egg by-products material 108 ready for further processing.

Milling the egg by-products material 100 reduces the particle size for separation based on density.

The milled egg by-products material 108 is transferred to a separator 110. In the separator 110, organic matter 112 and inorganic matter 120 are separated based on density. The inorganic matter 120 will be more dense than the organic matter 112, allowing for the two to be separated, e.g., via gravity separation. Organic matter 112 and inorganic matter 120 can be collected via several resulting streams.

The organic matter 112 may be sent downstream to one or more further processing machines 114 resulting in one or more final products, e.g., an eggshell membrane product 116 and/or other organic matter (e.g. feathers) 118. As is known to those of skill in the art, an eggshell membrane product 116 can be utilized in commercial products, such as supplements to promote joint health (e.g., collagen), and products found in the animal and pet industry. The eggshell membrane product 116 produced in accordance with the invention is a powder that preferably has a protein content equal to or greater than about 50%, and a collagen content equal to or greater than 2.5%.

The inorganic matter 120 may be primarily composed of eggshell calcium. The inorganic matter 120 may be transferred to a milling machine 122 to create milled, high purity eggshell calcium 124 of a desired particle size. The eggshell calcium 124 can be used in one or more applications as is known in the art, such as in animal feed. The eggshell calcium produced in accordance with the invention preferably has a calcium carbonate (CaCO₃) purity of at least about 87.5%.

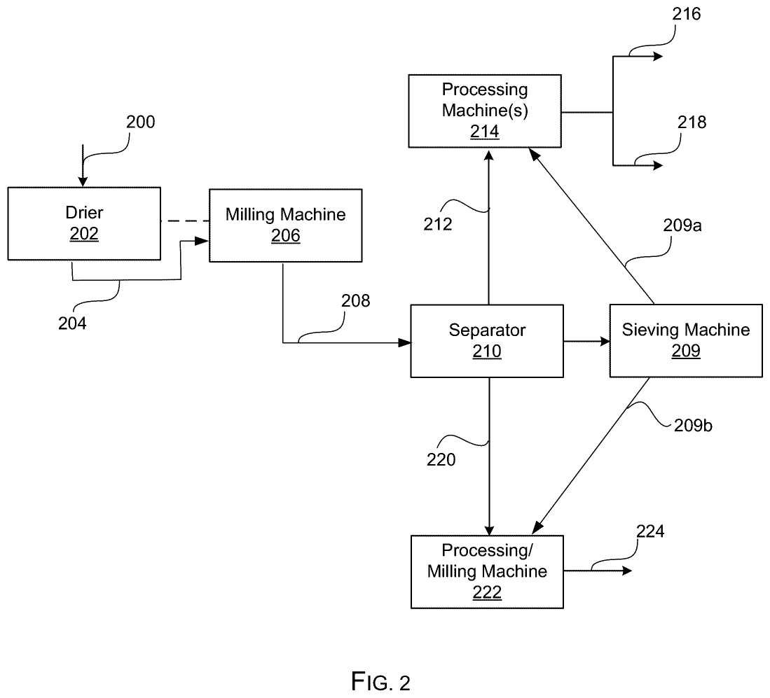

FIG. 2 illustrates yet another embodiment of a system and method of separating organic, and inorganic matter from egg by-products material 200 in accordance with the invention. As described in greater detail below, this embodiment, which is similar to the embodiment shown in FIG. 1 except as described herein, places a sieving machine 209 after the separator 210. Referring now to FIG. 2, the egg by-products material 200 is dried in a drier 202 resulting in a dried egg by-products material 204, which is subsequently milled in a milling machine 206 resulting in a milled egg by-products material 208.

The milled material 208 is transported to the separator 210 for separation into organic matter 212 and inorganic matter 220 based on density. Additionally, a portion of the milled egg by-products material 208 (e.g., material not able to separated in the separator 210) may be transported from the separator 210 to a sieving machine (typically a vibrating sieve machine) 209 for further separation into organic matter 209a and inorganic matter 209b based on particle size and density. As described for FIG. 1, the organic matter 212, 209a may be further processed via one or more processing machines 214 to provide organic final product(s), e.g., an eggshell membrane product 216 and/or other organic matter 218 (e.g. feathers). The inorganic matter 209b, 220 may be transferred to a milling machine 222, which may provide eggshell calcium 224 at a desired particle size and purity.

It will be appreciated by those skilled in the art that the specific drier 102, 202, milling machine 106, 206, separator 110, 210, one or more processing machines 114, 214, and sieving machine 209 may vary and be selected based on a number of factors, such as availability, efficiency, production volume, and associated costs.

### Trial Results

A first trial was completed on a sample of approximately 100 pounds of an egg by-products material containing unhatched eggs by-products, and comprising more than 35% organic matter by weight. After pressing out the liquid, the obtained macerated egg by-products material having a moisture content of about 25% was dried to a moisture content of less than about 1% by weight. The dried egg by-products material was then milled using a cutting-type mill (particle size of about 1 mm), followed by a separation by density in a gravity separator.

A stream of eggshells (inorganic source rich in inorganic matter) was obtained. The yield of eggshells (% of obtained eggshells compared to the starting amount of eggshells) was greater than 60% with a calcium carbonate purity greater than 90% (the target, taking into account benchmark products, was to be greater than 87.5%).

A stream of eggshell membrane product (containing membranes, embryos, dead chicks, without feathers) was collected. The eggshell membrane product yield (% of obtained organic matter without feathers related to the starting egg by-product material amount) was greater than 20%, with the protein in the eggshell membrane being greater than 50% (the target, taking into account benchmark products, was to be greater than 50%). The collagen content was greater than 6% (the target, taking into account benchmark products, was to be greater than 2.5%). It was observed that egg by-products material with a high biomass resulted in a high percent organic matter yield, which also had a positive impact on the percent protein and collagen content of the eggshell membrane product.

A second trial was completed on a sample of approximately 6000 pounds of egg by-products material containing unhatched eggs by-products, and comprising more than 35% organic matter by weight. After pressing out the liquid, the obtained macerated egg by-products material having a moisture content of about 25% was dried to a moisture content of less than about 3% by weight and substantially simultaneously grinded (particle size<1 mm), followed by a separation by density in a gravity separator. A vibratory sieving step was added to the process in order to further separate an obtained stream of organic and inorganic sources. The heavier material (inorganic source: shells) falls to the bottom while the lighter material (organic source: eggshell membrane) migrates to the top. These can then be collected separately.

After the additional sieving step, a stream of eggshells (inorganic source rich in inorganic matter) was obtained. The yield of eggshells (% of obtained eggshells compared to the starting amount of eggshells) was greater than 60% with a calcium carbonate purity greater than 90%.

A stream of eggshell membrane product (containing membranes, embryos, dead chicks, without feathers) was collected. The eggshell membrane product yield (% of obtained organic matter without feathers related to the starting egg by-products material amount) was 18%, with the protein in the eggshell membrane being greater than 50% (the target, taking into account benchmark products, was to be greater than 50%). The collagen content was greater than 6%.

It was observed that egg by-products material with a high biomass resulted in a high percent organic matter yield, which also had a positive impact on the percent protein and collagen content of the eggshell membrane product. Evaluation of the separated materials from the trials resulted in a determination that protein and collagen levels of eggshell by-product material having high organic matter content were markedly higher than starting materials with a lower biomass.

Features described above as well as those claimed below may be combined in various ways without departing from the scope hereof. The following examples illustrate some possible, non-limiting combinations:
(A1) A method of separating organic matter and inorganic matter from egg by-products material includes a drying step, a milling step, and a separating step. The egg-by products material includes at least unhatched egg by-products. In the drying step, an amount of egg by-products material is dried to create a dried egg by-products material. During the milling step, the dried egg by-products material is milled to create a milled egg by-products material. The milled egg by-products material is then separated into an amount of organic matter and an amount of inorganic matter in the separating step.
(A2) For the method denoted as (A1), the method additionally includes a pre-processing step during which egg by-products material is pressed to form macerated egg by-products material.
(A3) For the method denoted as (A1), the amount of egg by-products material includes an amount of unhatched egg by-products between 15% and 50%.
(A4) For method denoted as (A2), a moisture level of the macerated egg by-products material is greater than 20%.
(A5) For method denoted as (A4), a moisture level of the macerated egg by-products material is greater than 25%.
(A6) The method denoted as (A1), wherein a moisture level of the dried egg by-products material is less than about 10%.
(A7) For the method denoted as (A1), the milling step create a milled egg by-products material with a predetermined particle size.
(A8) For method denoted as (A1), the milled egg by-products material is separated into an amount of organic matter and an amount of inorganic matter based on density of the organic matter and the inorganic matter.
(A9) For the method denoted as (A8), the separating step further comprises a sieving step after the separating step by density.
(A10) The method denoted as (A1) further includes a processing step wherein the obtained amount of inorganic matter is processed to form eggshell calcium.
(A11) For the method denoted as (A10), the processing step includes milling the obtained inorganic matter.
(A12) For the method denoted as (A10), the obtained eggshell calcium has a calcium carbonate purity of greater than 87.5%.
(A13) The method denoted as (A1) further includes a processing step wherein the obtained organic matter is processed to form an eggshell membrane product.
(A14) A system that implements the methods denoted as (A1)-(A13) includes at least one drier that performs the drying step; at least one milling machine that performs the milling step; and at least one separator that performs the separating step.
(A15) In a system implementing the method denoted as (A9), a sieving machine performs the sieving step.
(A16) Eggshell calcium obtained according to the method denoted in (A1) is obtained from the inorganic matter.
(A17) The eggshell calcium obtained according to the method denoted in (A16) has a calcium carbonate purity of greater than 87.5%.
(A18) An eggshell membrane product obtained according to the method denoted in (A1) is obtained from the organic matter.
(A19) A method of separating organic matter and inorganic matter from mixed eggshell by-product material includes drying an amount of mixed eggshell by-product material to form a dried eggshell material; milling the dried eggshell by-product material to form a milled eggshell material; separating an amount of organic matter and an amount of inorganic matter from the milled eggshell material; and processing the amount of organic matter and/or the amount of inorganic matter to create one or more final products.
(A20) For the method denoted as (A19), the amount of mixed eggshell by-product material at least partially comprises unhatched egg by-products.
(A21) For the method denoted as (A19), the amount of eggshell by-product material comprises at least 98% by weight of unhatched egg by-products.
(A22) For the method denoted as (A19), the amount of eggshell by-product material comprises at least 99% by weight of unhatched egg by-products.
(A23) For the method denoted as (A19), the amount of eggshell by-product material comprises at least 99.9% by weight of unhatched egg by-products.
(A24) For the method denoted as (A19), the amount of eggshell by-product material consists essentially of unhatched egg by-products.
(A25) For the method denoted as (A19), the amount of eggshell waste material includes an amount of unhatched eggs.
(A26) For the method denoted as (A19), the amount of eggshell by-product material includes an amount of unhatched eggs of up to 50% by weight.
(A27) For the method denoted as (A19), a moisture level of the dried eggshell material is less than about 10% by weight.
(A28) For the method denoted as (A27), the moisture level of the dried eggshell material is less than about 7% by weight.
(A29) For the method denoted as (A19), a moisture level of the amount of mixed eggshell by-product material is greater than about 20% by weight.
(A30) For the method denoted as (A19), processing the amount of inorganic matter includes milling the amount of inorganic matter into an amount of eggshell calcium.
(A31) For the method denoted as (A19), processing the amount of organic matter includes separating an amount of eggshell membrane from the amount of organic matter.
(A32) For the method denoted as (A19), separating the amount of organic matter and the amount of inorganic matter from the milled eggshell material comprises sieving the milled eggshell material, which results in a first stream comprising inorganic matter and a second stream comprising organic matter and inorganic matter.
(A33) The method denoted as (A32) further includes further separating the second stream into a third stream comprising inorganic matter and a fourth stream comprising organic matter, in which the separation is based on a respective density of the inorganic matter and the organic matter.
(A34) For the method denoted as (A33), processing the inorganic matter comprises milling the first and fourth streams to a predetermined particle size.
(A35) For the methods denoted (A33) or (A34), processing the organic matter comprises further separating the third stream to provide an amount of eggshell membrane.
(A36) For the method denoted as (A19), separating the milled eggshell material results in a first organic matter stream, a second inorganic matter stream, and a third stream comprising organic and inorganic matter.
(A37) For the method denoted as (A36), the separating occurs based on a respective density of the organic matter and the inorganic matter.
(A38) The methods denoted (A36) or (A37) further include sieving the third stream into a fourth stream comprising organic matter and a fifth stream comprising inorganic matter.
(A39) For the method denoted as (A38), processing the inorganic matter comprises milling the second and fifth streams to a predetermined particle size.
(A40) For the methods denoted (A38) or (A39), processing the organic matter comprises further separating the first stream and the fourth stream to provide an amount of eggshell membrane.
(A41) A method of separating organic matter and inorganic matter from mixed eggshell by-product material includes a drying step, a milling step, a separating step, and a processing step. In the drying step, an amount of mixed eggshell by-product material is dried to create a dried eggshell material. During the milling step, the dried eggshell material is milled to create a milled eggshell material. The milled eggshell material is separated based on density into an amount of organic matter and an amount of inorganic matter in the separating step. And in the processing step, the amount of organic matter and/or the amount of inorganic matter is processed to create one or more final products.
(A42) For the method denoted as (A41), the amount of mixed eggshell by-product material at least partially comprises macerated egg by-products material.
(A43) For the method denoted as (A41), the amount of mixed eggshell by-product material comprises at least 98% by weight of macerated egg by-products material.
(A44) For the method denoted as (A41), the amount of mixed eggshell by-product material comprises at least 99% by weight of macerated egg by-products material.
(A45) For the method denoted as (A41), the amount of mixed eggshell by-product material comprises at least 99.9% by weight of macerated egg by-products material.
(A46) For the method denoted as (A41), the amount of mixed eggshell by-product material consists essentially of macerated egg by-products material.
(A47) For the method denoted as (A41), the amount of mixed eggshell by-product material includes a level of unhatched eggs.
(A48) For the method denoted as (A47), the amount of mixed eggshell by-product material includes a level of unhatched eggs of up to 50%.
(A49) For the method denoted as (A41), a moisture level of the dried eggshell material is less than about 10%.
(A50) For the method denoted as (A49), a moisture level of the dried eggshell material is less than about 7%.
(A51) For the method denoted as (A41), a moisture level of the amount of mixed eggshell by-product material is greater than about 20%.
(A52) For the method denoted as (A41), the processing step includes milling the amount of inorganic matter into an amount of eggshell calcium.
(A53) For the method denoted as (A52), the processing step includes separating an amount of eggshell membrane from the amount of organic matter.
(A54) For the method denoted as (A41), the processing step includes separating an amount of eggshell membrane from the amount of organic matter.
(A55) The method denoted as (A41) further includes a sieving step to at least partially filter inorganic matter from organic matter.
(A56) For the method denoted as (A55), the sieving step is completed before the separating step, which results in a first stream comprising inorganic matter and a second stream comprising inorganic matter and organic matter, and the second stream is subject to the separating step.
(A57) For the method denoted as (A55), the sieving step is completed after the separating step, and the separating step results in a first stream comprising organic matter, a second stream comprising inorganic matter, and a third stream comprising organic matter and inorganic matter, the third stream being subject to the sieving step.
(A58) For the methods denoted (A25)-(A40) and (A47)-(A57), the mixed eggshell by-product material at least partially comprises macerated egg by-products material.
(A59) For the methods denoted (A25)-(A40) and (A47)-(A57), the amount of mixed eggshell by-product material comprises at least 98% by weight of macerated egg by-products material.
(A60) For the methods denoted (A25)-(A40) and (A47)-(A57), the amount of mixed eggshell by-product material comprises at least 99% by weight of macerated egg by-products material.
(A61) For the methods denoted (A25)-(A40) and (A47)-(A57), the amount of mixed eggshell by-product material comprises at least 99.9% by weight of macerated egg by-products material.
(A62) For the methods denoted (A25)-(A40) and (A47)-(A56), the amount of mixed eggshell by-product material consists essentially of macerated egg by-products material.
(A63) For the methods denoted (A20)-(A24) or (A27)-(A35), the amount of mixed eggshell by-product material includes a level of unhatched eggs.
(A64) For the method denoted as (A63), the level of unhatched eggs is less than 50% by weight.
(A65) For the methods denoted (A41)-(A46) or (A49)-(A58), the amount of mixed eggshell by-product material includes a level of unhatched eggs.
(A66) For the method denoted as (A65), the level of unhatched eggs is less than 50% by weight.
(A67) For the methods denoted (A20)-(A26) or (A30)-(A40), a moisture level of the amount of mixed eggshell by-product material is greater than about 20% by weight, more particularly about 25% by weight; and a moisture level of the dried eggshell material is less than about 10% by weight.
(A68) For the methods denoted (A42)-(A48) or (A52)-(A60), a moisture level of the amount of mixed eggshell by-product material is greater than about 20% by weight, more particularly about 25% by weight; and a moisture level of the dried eggshell material is less than about 10% by weight.
(A69) For the methods denoted (A19)-(A29) or (A32)-(A33), the one or more final products include one or more items selected from a group consisting of an amount of eggshell calcium milled from the amount of inorganic matter and an amount of eggshell membrane separated from the amount of organic matter.
(A70) For the methods denoted (A42)-(A50) or (A55)-(A62), the one or more final products include one or more items selected from a group consisting of an amount of eggshell calcium milled from the amount of inorganic matter and an amount of eggshell membrane separated from the amount of organic matter.
(A71) The methods denoted (A20)-(A31) further include sieving the milled eggshell material to filter inorganic material organic material.
(A72) The methods denoted (A42)-(A53) further include a sieving step to at least partially filter inorganic matter from organic matter.
(A73) In a system implementing the method denoted (A41)-(A57), at least one drier performs the drying step; at least one milling machine performs the milling step; and at least one separator performs the separating step.
(A74) In a system implementing the methods denoted (A55)-(A57), a sieving machine performs the sieving step.

Many different arrangements of the various components depicted, as well as components not shown, are possible without departing from the spirit and scope of the present disclosure. Embodiments of the present disclosure have been described with the intent to be illustrative rather than restrictive. Alternative embodiments will become apparent to those skilled in the art that do not depart from its scope. A skilled artisan may develop alternative means of implementing the aforementioned improvements without departing from the scope of the present disclosure. It will be understood that certain features and subcombinations are of utility and may be employed without reference to other features and subcombinations. Not all steps listed in the various figures need be carried out in the specific order described.

1. A method of separating organic matter and inorganic matter from egg by-products material comprising at least unhatched egg by-products, comprising:
a drying step wherein an amount of egg by-products material is dried to create a dried egg by-products material;
a milling step wherein the dried egg by-products material is milled to create a milled egg by-products material; and
a separating step wherein the milled egg by-products material is separated into an amount of organic matter and an amount of inorganic matter.

2. The method of claim 1, comprising a pre-processing step of pressing egg by-products material to form macerated egg by-products material.

3. The method of claim 1, wherein the amount of egg by-products material includes an amount of unhatched egg by-products between 15% and 50%.

4. The method of claim 2, wherein a moisture level of the macerated egg by-products material is greater than 20%.

5. The method of claim 4, wherein a moisture level of the macerated egg by-products material is greater than 25%.

6. The method of claim 1, wherein a moisture level of the dried egg by-products material is less than about 10%.

7. The method of claim 1, wherein the milling step creates a milled egg by-products material with a predetermined particle size.

8. The method of claim 1, wherein the milled egg by-products material is separated into an amount of organic matter and an amount of inorganic matter based on density of the organic matter and the inorganic matter.

9. The method of claim 8, wherein the separating step further comprises a sieving step after the separating step by density.

10. The method of claim 1, further comprising a processing step wherein the obtained amount of inorganic matter is processed to form eggshell calcium.

11. The method of claim 10, wherein the processing step includes milling the obtained inorganic matter.

12. The method of claim 10, wherein the obtained eggshell calcium has a calcium carbonate purity of greater than 87.5%.

13. The method of claim 1, further comprising a processing step wherein the obtained organic matter is processed to form an eggshell membrane product.

14. A system implementing the method of claim 1, wherein:
at least one drier performs the drying step;
at least one milling machine performs the milling step; and
at least one separator performs the separating step.

15. A system implementing the method of claim 9, wherein:
a sieving machine performs the sieving step.

16. Eggshell calcium obtained according to the method of claim 1, wherein the eggshell calcium is obtained from the inorganic matter.

17. The eggshell calcium of claim 16, wherein the obtained eggshell calcium has a calcium carbonate purity of greater than 87.5%.

18. An eggshell membrane product obtained according to the method of claim 1, wherein the eggshell membrane product is obtained from the organic matter.

19. A method of separating organic matter and inorganic matter from mixed eggshell by-product material, comprising:
drying an amount of mixed eggshell by-product material to form a dried eggshell material;
milling the dried eggshell by-product material to form a milled eggshell material;
separating an amount of organic matter and an amount of inorganic matter from the milled eggshell material; and
processing the amount of organic matter and/or the amount of inorganic matter to create one or more final products.
